(19) United States
(12) Patent Application Publication
(10) Pub. No.: US 2016/0031612 A1
(43) Pub. Date: Feb. 4, 2016

(54) TIP SEAL TILT VALVE

(71) Applicant: PRECISION VALVE CORPORATION, Rye Brook, NY (US)

(72) Inventors: John B. FORE, Travelers Rest, SC (US); Geoffrey BRACE, Columbus, NC (US)

(21) Appl. No.: 14/776,116

(22) PCT Filed: Mar. 14, 2014
(86) PCT No.: PCT/US2014/027767

§ 371 Date: Sep. 14, 2015

Related U.S. Application Data
(60) Provisional application No. 61/789,250, filed on Mar. 15, 2013.

(51) Int. Cl. B65D 47/24; F16K 1/46; F16K 27/02; F16K 1/34

(52) U.S. Cl. CPC B65D 47/248; F16K 1/34; F16K 1/46; F16K 27/02

(57) ABSTRACT

A valve is provided that includes a tip seal assembly, a mounting cup that has a hole, and a housing that is connected to the mounting cup. The tip seal assembly has a first portion through the hole forming a gap between the mounting cup and the first portion of the tip seal assembly. The tip seal assembly has a second portion in the housing. A shell seal is between the housing and the tip seal assembly covering the gap. The shell seal is deformable to form an opening between the housing and the tip seal assembly upon application of a predetermined pressure through the gap.

### BACKGROUND OF THE DISCLOSURE

1. Field of the Disclosure

The present disclosure relates to a tip seal tilt valve. More particularly, the present disclosure relates to a tip seal tilt valve for pressurized dispensing containers.

2. Discussion of the Related Art

Many different types of products are sold in containers that incorporate tip valves to enable a consumer to access the contents of the container. For example, products such as expanding foam shaving gel, expanding foam toothpaste, a variety of food products and expanding foam hair products, are sold in containers that have tip valves. A consumer deflects a tilt valve on a container containing the product to release the product from the container.

Such expanding foam products can cause “after drool” where the volume of product remaining in any product channel downstream of the valve seal expands and extrudes out from the product delivery orifice of the container.

The methods and systems described below reduce or prevent such “after drool” or unwanted dispense of the product, for example, so that a volume of food product exposed to atmosphere is reduced to close to zero after the valve closes and therefore minimizes the potential for degradation.

The present disclosure also provides many additional advantages, which shall become apparent as described below.

### SUMMARY OF THE DISCLOSURE

The present disclosure provides a valve that includes a tip seal assembly, a housing and a mounting cup. The mounting cup has a hole. The tip seal assembly has a first portion through the hole forming a gap between the mounting cup and the first portion of the tip seal assembly. The housing is connected to the mounting cup. The tip seal assembly has a second portion in the housing. A shell seal is between the housing and the tip seal assembly covering the gap. The shell seal is deformable to form an opening between the housing and the tip seal assembly upon application of a predetermined pressure through the gap.

Further objects, features and advantages of the present disclosure will be understood by reference to the following drawings, detailed description and appended claims.

### BRIEF DESCRIPTION OF THE DRAWINGS

FIG. 1 is a partial axial cross-sectional view of a tip seal tilt valve of an aerosol valve system of the present disclosure illustrating the tip seal tilt valve in a closed fill position.

FIG. 2 is a partial axial cross-sectional view of the tip seal tilt valve of FIG. 1 illustrating the tip seal tilt valve in an open fill position.

FIG. 3 is an enlarged partial axial cross-sectional view of the tip seal tilt valve of FIG. 2.

FIG. 4 is a side view of a stem according to the present disclosure.

FIG. 5 is a partial axial cross-sectional view of the tip seal tilt valve of FIG. 1 illustrating the tip seal tilt valve in the closed dispense position and a closed fill position connected to a bag-on-valve aerosol assembly that is filled with a product and a propellant.

FIG. 6 is an enlarged partial axial cross-sectional view of the tip seal tilt valve of FIG. 5.

FIG. 7 is a cross-sectional view taken along A-A of FIG. 6 of the tip seal tilt valve of FIG. 5.

FIG. 8 is a partial axial cross-sectional view of the tip seal tilt valve of FIG. 1 illustrating the tip seal tilt valve in the open, dispense position and a closed, fill position.

FIG. 9 is an enlarged partial axial cross-sectional view of the tip seal tilt valve of portion B of FIG. 8.

FIG. 10 is an enlarged partial axial cross-sectional view of the tip seal tilt valve of portion C of FIG. 8.

FIG. 11 is an enlarged partial axial cross-sectional view of a tip seal tilt valve of an aerosol valve system of the present disclosure illustrating the tip seal tilt valve in a closed fill position and having an alternative cup.

### DETAILED DESCRIPTION OF THE PREFERRED EMBODIMENT

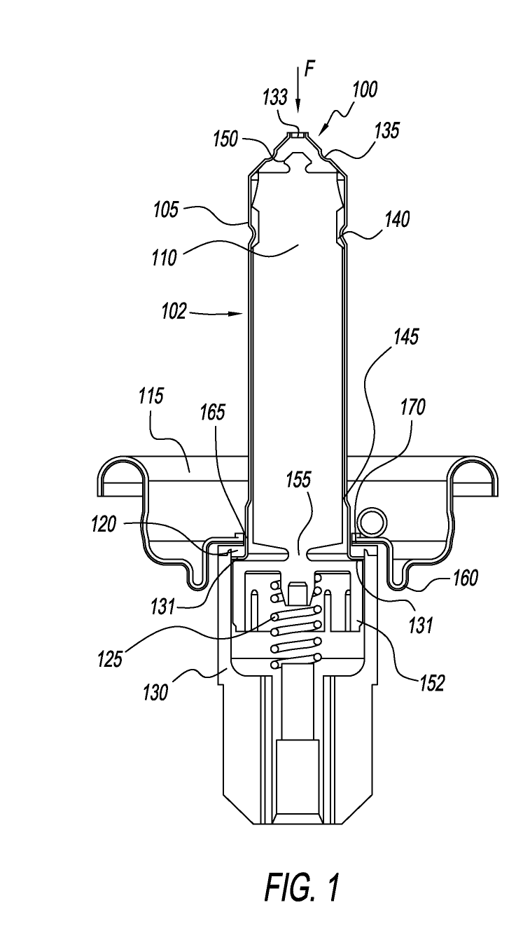

Referring to the drawings and in particular to FIG. 1, an exemplary embodiment of a tip seal tilt valve according to the present disclosure is shown and is generally referred to by reference numeral 100 (“valve 100”) in a closed fill position. Valve 100 has a tip seal assembly 102 formed by a shell 105 and stem 110. Valve 100 has a mounting cup 115, a shell seal 120, a spring 125, and a housing 130. Shell 105 has a flange 131, an aperture 133, a seal ring 135, a stem ring 140 and a shoulder 145. Stem 110 has a tip seal 150, a stem base 152 and a pivot point 155. Spring 125 is between stem base 152 and housing 130. Mounting cup 115 has a crimp 160 and a hole 165. Housing 130 has a shape that is a wedge. A gap 170 is formed between mounting cup 115 and shell 105. Shell seal 120 is between mounting cup 115, housing 130 and flange 131 of shell 105 sealing gap 170 in the closed fill position. A force F is applied to tip seal assembly 102 moving tip seal assembly 102 in a direction of force F from the closed fill position to an open fill position.

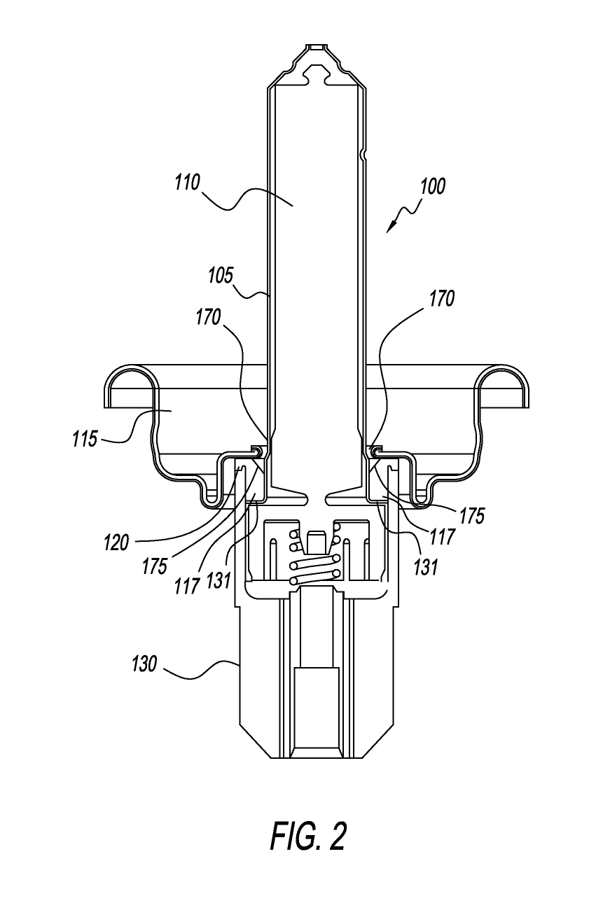

Referring to FIG. 2, valve 100 is in the open fill position. Flange 131 of shell 105 is moved away from mounting cup 115 to form a space 117 between shell seal 120 and flange 131 in the open fill position. Shell seal 120 can be deformed in space 117 to form an opening 175 between housing 130 and shell 105 upon application of a predetermined pressure through gap 170.

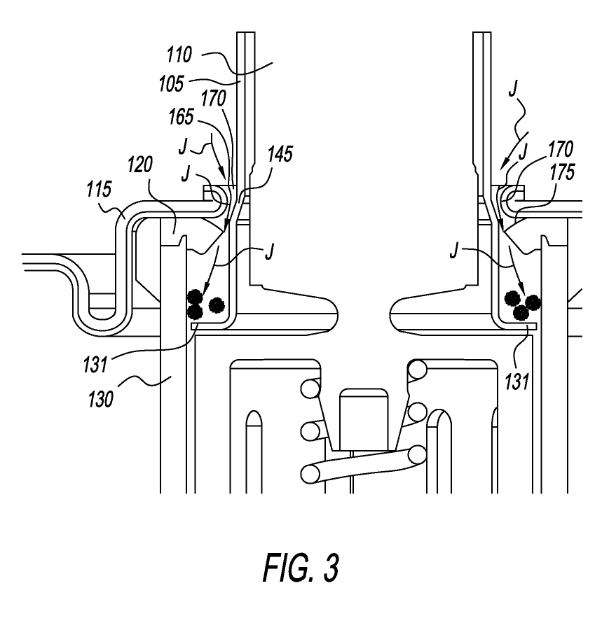

Referring to FIG. 3, arrows J illustrate fluid, for example, product, of a predetermined pressure that flows through gap 170 and opening 175. The product flow illustrated by arrows J may flow into a bag of an aerosol dispenser, such as the shown bag-on-valve aerosol dispenser, during a product pressure filling process to store the product prior to dispensing. When force F is no longer applied to tip seal assembly 102, tip seal assembly 102 moves in a direction opposite to force F from the opened fill position to the closed fill position shown in FIG. 1 so that fluid may no longer pass through gap 170 and opening 175. Tip seal assembly 102 moves in the direction opposite to force F from the opened fill position to the closed fill position by a force applied by spring 125 and/or a force applied by the product resulting from a pressure applied to the bag storing the product by a propellant that urges stem 110 to return to the closed dispense position preventing dispense of the product out of valve 100.

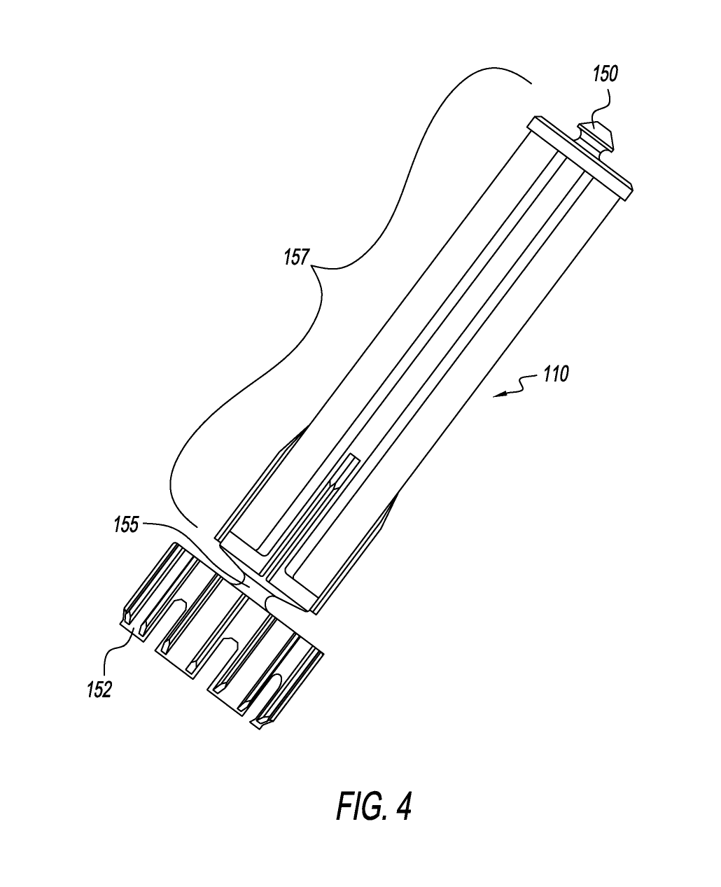

Referring to FIG. 4, stem 110 is shown. Stem 110 has a flexible portion 157. Pivot point 155 is flexible.

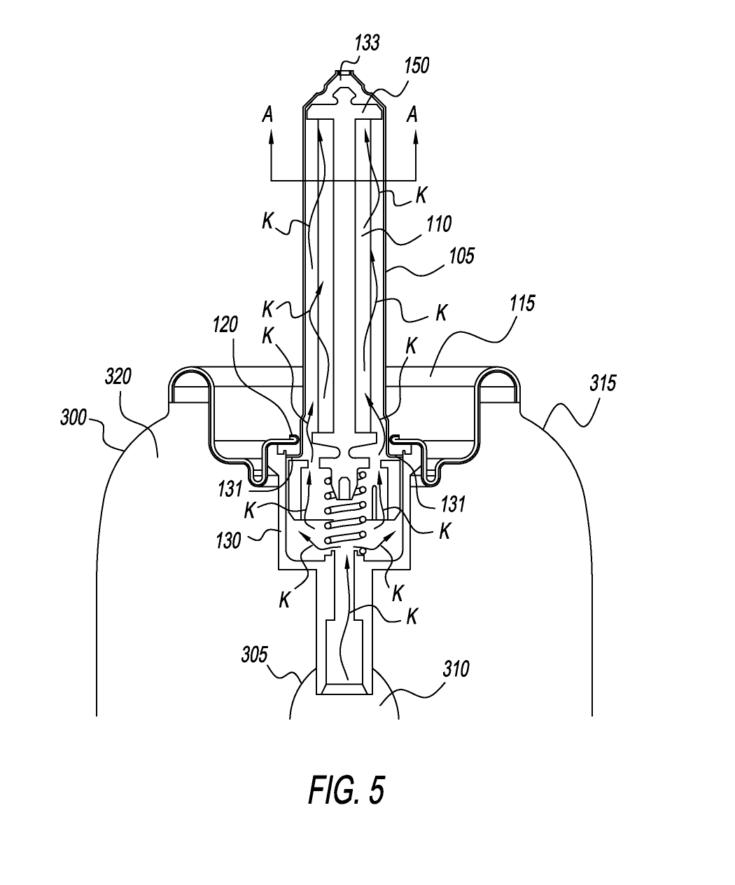

Referring to FIG. 5, valve 100 is in the closed dispense position and a closed fill position. Valve 100 is connected to a bag-on-valve aerosol assembly 300 having a bag 305 filled with a product 310 and a container 315 filled with a propellant 320. The propellant 320 applies a pressure to bag 305 that urges product 310 to flow along arrows K. The flow along arrows K urges tip seal 150 against shell 105 so that product 310 does not flow through aperture 133 through shell 105.

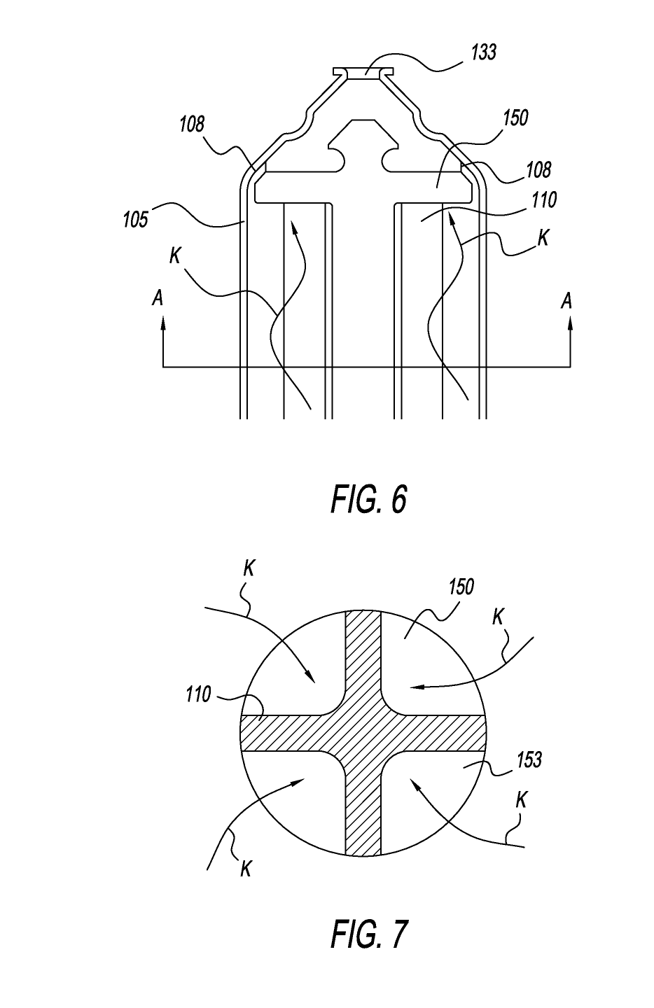

Referring to FIG. 6, the flow along arrows K of product 310 applies a pressure to an underside surface 108 of shell 105 that supports tip seal 150.

Referring to FIG. 7, the flow along arrows K of product 310 applies a pressure to tip seal 150.

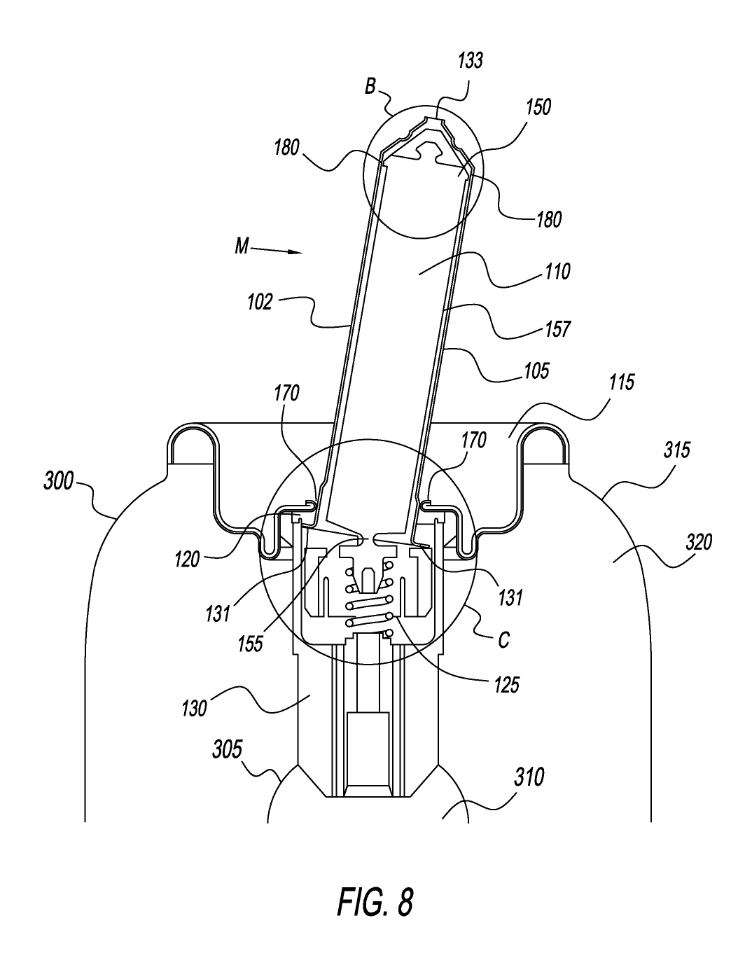

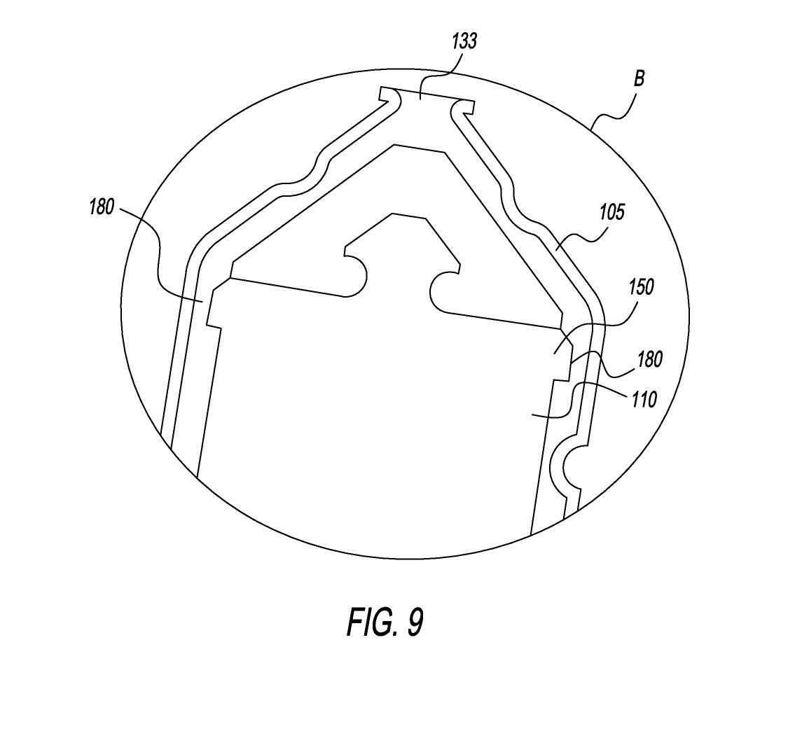

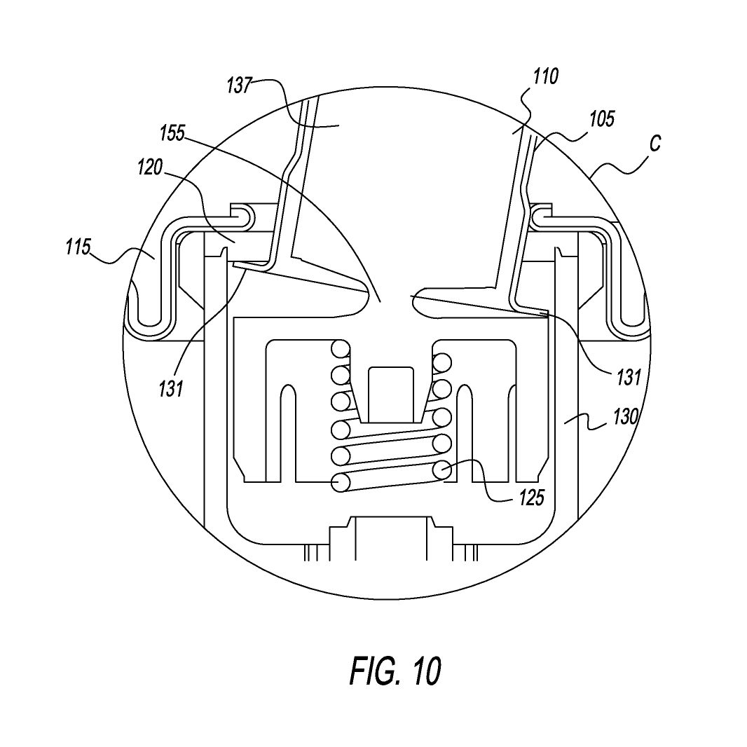

Referring to FIGS. 8-10, a force M is applied to valve 100 to move valve 100 from the closed dispensed position to an open dispense position. When valve 100 remains in the closed fill position, the force M applied to shell 105 moves flexible portion 157 about pivot point 155 so pivot point 155 bends in the direction of force M and tip seal 150 moves away from aperture 133 and shell 105 surrounding aperture 133 forming a separation 180 between tip seal 150 and shell 105. Shell seal 120 covers gap 170 in the open dispense position. Shell seal 120 contacts shell 105, cup 115 and housing 130 in the open dispense position. Valve 100 is connected to the bag-on-valve aerosol assembly 300. The propellant 320 applies a pressure to bag 305 that urges product 310 toward tip seal 150 between housing 130 and stem 110, between shell 105 and stem 110 and through separation 180, and out of aperture 133 to dispense the product out of valve 100. When force M is no longer applied to shell 105, spring 125 and/or pivot point 155 and/or the force applied by the product resulting from the pressure applied to bag 305 by propellant 320 urges stem 110 to return to the closed dispense position preventing dispense of the product out of valve 100.

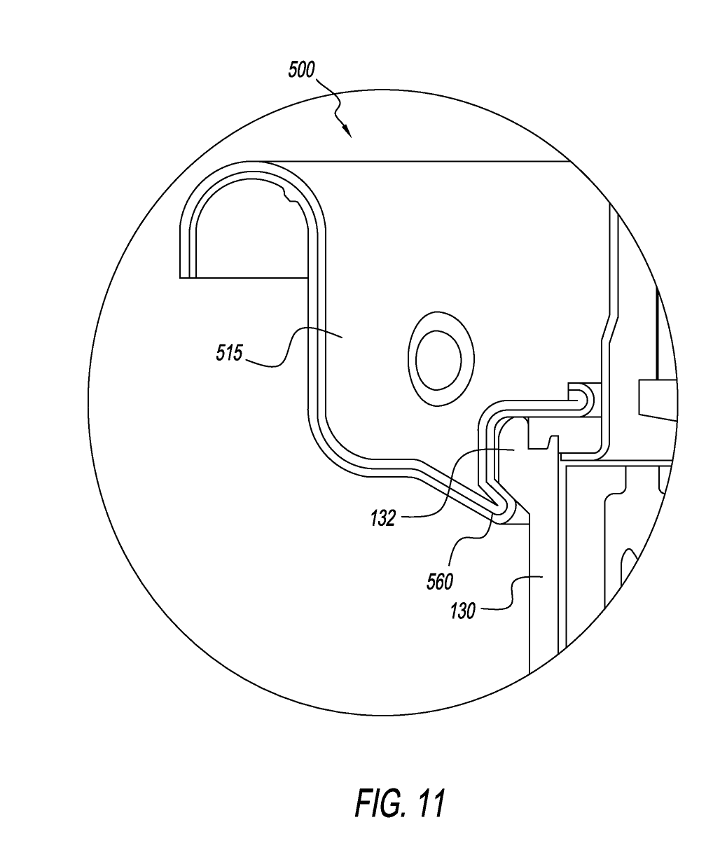

Referring to FIG. 11, an exemplary embodiment of a tip seal tilt valve according to the present disclosure is shown and is generally referred to by reference numeral 500 (“valve 500”) in a closed fill position. Valve 500 is the same as valve 100, however, has an alternative cup 515. Cup 515 has a crimp 560 that extends around a rim 132 of housing 130.

Rim 132 and crimp 160 and 560 prevent or eliminate the possibility of the product being forced into container 315 during the product pressure filling process.

Shell 105 profile is contoured. Gap 170 between cup 115 and shell 105 has an increase in width by a reduction in an outside diameter of shell 105 at shoulder 145, as shown in FIG. 3, which becomes coincident/adjacent to hole 165 when valve 100 is fully depressed axially in the direction of force F during the filling operation. This maximizes product fill speed with stem 110 fully depressed axially while still retaining integrity of shell seal 120 during product dispensing.

Stem 110 is ‘necked’ or has pivot point 155 to both reduce force to move valve 100, 500 from the closed dispense position to the open dispensed position and to establish a specific pivot point for the differential movement between the stem 110 and shell 105 components thus providing consistent opening product-flow profile.

Tip seal 150 downstream end is shaped to utilize container 300 internal pressure to supplement the mechanical spring pressure of spring 125 to ensure a positive seal at rest—tests may prove that a spring may not be needed for valve 100, 500 to function satisfactorily—this may be advantageous for products where exposure to metal components may cause degradation.

Valve 100, 500 improves a sealing function by providing conformance to shell 105 top surface contour and orifice geometry. Seal ring 135 and/or stem ring 140 intensifies the sealing performance by concentrating the closing force of the valve spring and canister pressure over a smaller surface area.

The distance of tip seal 150 from aperture 133 reduces or eliminates “after drool” or unwanted dispense of the product by minimizing product channels downstream of tip seal 150.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the scope thereof. Therefore, it is intended that the present disclosure not be limited to the particular embodiment(s) disclosed as the best mode contemplated, but that the present disclosure will include all embodiments falling in the scope of the appended claims.

What is claimed is:

1. A valve comprising:
a tip seal assembly, said tip seal assembly having a first portion and a second portion;
a mounting cup having a hole, said first portion of said tip seal assembly through said hole forming a gap between said mounting cup and said first portion;
a housing connected to said mounting cup, said second portion of said tip seal assembly being in said housing;
a shell seal between said housing and said tip seal assembly covering said gap, said shell seal being deformable to form an opening between said housing and said tip seal assembly upon application of a predetermined pressure through said gap.

2. The valve of claim 1, wherein said tip seal assembly has a shell and a stem inside said shell.

3. The valve of claim 2, wherein said gap is increased in width by a reduction in an outside diameter of said shell at a shoulder that becomes adjacent to said hole when said tip seal assembly is depressed in a direction of a force applied during a filling operation.

4. The valve of claim 1, wherein the mounting cup has a crimp that extends around a rim of the housing preventing a product in a bag from being forced into a container having propellant therein during a product pressure filling process.

5. The valve of claim 2, wherein said stem has a flexible portion connected to a base, and wherein said flexible portion has a pivot point and a tip seal covering an aperture through said shell.

6. The valve of claim 5, wherein said tip seal has a shape that is urged against said shell by a flow of propellant.

7. The valve of claim 5, wherein when a force is applied to said tip seal assembly to move said tip seal assembly from a closed dispensed position to an open dispense position, said flexible portion moves about said pivot point so said pivot point bends in a direction of said force and said tip seal moves away from said aperture through said shell forming a separation between said tip seal and said shell.

8. The valve of claim 7, wherein, in said open dispense position, the valve has product that is urged toward said tip seal between said housing and said stem, between said shell and said stem and through said separation, and out of said aperture to dispense said product out of the valve.

9. The valve of claim 2, wherein said tip seal has a pressure applied to said tip seal by a flow of a product that applies a pressure to an underside surface of said shell that supports said tip seal.

10. The valve of claim 2, wherein said shell has a seal ring above said tip seal that has a width that is smaller than portions of said shell adjacent to said seal ring to concentrate a closing force over a smaller surface area.

11. The valve of claim 2, wherein said shell has a stem ring below said tip seal that has a width that is smaller than portions of said shell adjacent to said seal ring to concentrate a closing force over a smaller surface area.

12. A tip seal assembly comprising:
a shell; and
a stem inside said shell, said stem having a flexible portion connected to a base, and said flexible portion having a pivot point and a tip seal covering an aperture through said shell, said pivot point and said tip seal are on opposite sides of said flexible portion, and said tip seal having a shape that is urged against said shell by a flow of propellant.

13. The tip seal assembly of claim 12, wherein said shell has a reduction in an outside diameter at a shoulder.

14. The tip seal assembly of claim 12, wherein when a force is applied to the tip seal assembly to move the tip seal assembly from a closed dispensed position to an open dispense position, said flexible portion moves about said pivot point so said pivot point bends in a direction of said force and said tip seal moves away from said aperture through said shell forming a separation between said tip seal and said shell.

15. The valve of claim 12, wherein said tip seal has a pressure applied to said tip seal by a flow of a product that applies a pressure to an underside surface of said shell that supports said tip seal.

16. The valve of claim 12, wherein said shell has a seal ring above said tip seal that has a width that is smaller than portions of said shell adjacent to said seal ring to concentrate a closing force over a smaller surface area.

17. The valve of claim 12, wherein said shell has a stem ring below said tip seal that has a width that is smaller than portions of said shell adjacent to said seal ring to concentrate a closing force over a smaller surface area.
